(19) United States
(12) Patent Application Publication
(10) Pub. No.: US 2015/0020748 A1
(43) Pub. Date: Jan. 22, 2015

(54) ERRATIC BOUNCE AND ROLL TOY

(71) Applicant: Lawrence I. Wechsler, Great Neck, NY (US)

(72) Inventor: Lawrence I. Wechsler, Great Neck, NY (US)

(21) Appl. No.: 14/311,360

(22) Filed: Jun. 23, 2014

Related U.S. Application Data
(60) Provisional application No. 61/838,074, filed on Jun. 21, 2013.

(51) Int. Cl. A63B 43/00; A01K 15/02

(52) U.S. Cl. CPC A63B 43/002; A01K 15/025
USPC 119/711; 446/437; 119/707

(57) ABSTRACT

A pet toy includes a structural configuration in which a center of gravity is displaced from a geometric center of the toy so as to provide erratic kinetic movement.

### BACKGROUND OF THE INVENTION

The present invention relates to a toy, and more particularly, to a toy that can provide enhanced erratic bounce and/or roll, and which is suited, for example, to use as a pet toy.

Fetch, activity and chew toys are well known products in the pet trade. These can take the general shape of a ball or sphere, or other arbitrary geometric or representational shape, such as an animal or character. It has been perceived as an advantage to provide such toys in a form that provides an erratic bounce, since it is thought that such movement arouses the natural predatory instincts of some animals, including dogs and cats, and will elicit greater interest on the part of the pet for the particular toy.

Such toys are comprised of various materials, including rubber, vinyl or other elastomer, cloth, plastic, etc.

Attempts have heretofore been made to impart improved erratic or unpredictable bounce to pet toys by altering their outside shape, such that the toy strikes a surface from which it is bounced at various impact positions along the outer facing toy surface located varying distances and directions from a center of gravity. One such well known toy is currently available on the market under the trade name CLASSIC KONG. Comprised of a rubber compound, the toy includes three differently sized roughly spherical sections arranged one atop the other.

While effective for providing erratic bounce, the outer envelope of such a toy is limited to a non-spherical shape, which is required to achieve the erratic bounce effect. Because of the discontinuous surface curvatures of the outer envelope of the toy, the toy is not readily rollable.

It would therefore be desirable to provide a toy which provides erratic bounce and/or roll qualities without the mandatory requirement that the general outer envelope be other than generally spherical or that it be geometrically non-symmetric about a geometric center, or have a geometric center necessarily coincident with a center of gravity.

### SUMMARY OF THE INVENTION

It is an object of the invention to provide a toy which overcomes the drawbacks of the prior art.

In accordance with these and other objects of the invention, there is provided a pet toy which includes a structural configuration that displaces a center of gravity (i.e., center of mass) from a geometric center (i.e., center of geometry or centroid) of the toy.

In an advantageous embodiment, provided herein by example, the toy according to the invention includes an outer envelope defined by at least three arcuate ribs extending longitudinally between toy poles disposed at either end, leaving a hollow interior region inwardly thereof.

In accordance with the embodiment, one or more structural configurations are effective for providing the desired erratic behavior of the toy. For example, one configuration can include locating the longitudinal axis extending between the poles eccentrically of the toy geometrical center. Another adaptation involves placing a weighted portion within the hollow interior region of the toy in a position offset from the geometrical center, and which would otherwise coincide with the center of gravity. Additionally, a further degree of unpredictable bounce can be optionally achieved by providing the toy with an exterior shape of non-spherical shape.

The above, and other objects, features and advantages of the present invention will become apparent from the following description read in conjunction with the accompanying drawings.

### BRIEF DESCRIPTION OF THE DRAWINGS

FIG. 1 is perspective view of an embodiment of a pet toy according to the invention;

FIG. 2 is a plan view of the pet toy of FIG. 1;

FIG. 3 is a projected side elevational view of the pet toy of FIG. 2; and

FIG. 4 is a cross-sectional view taken along line 4-4 in FIG. 2.

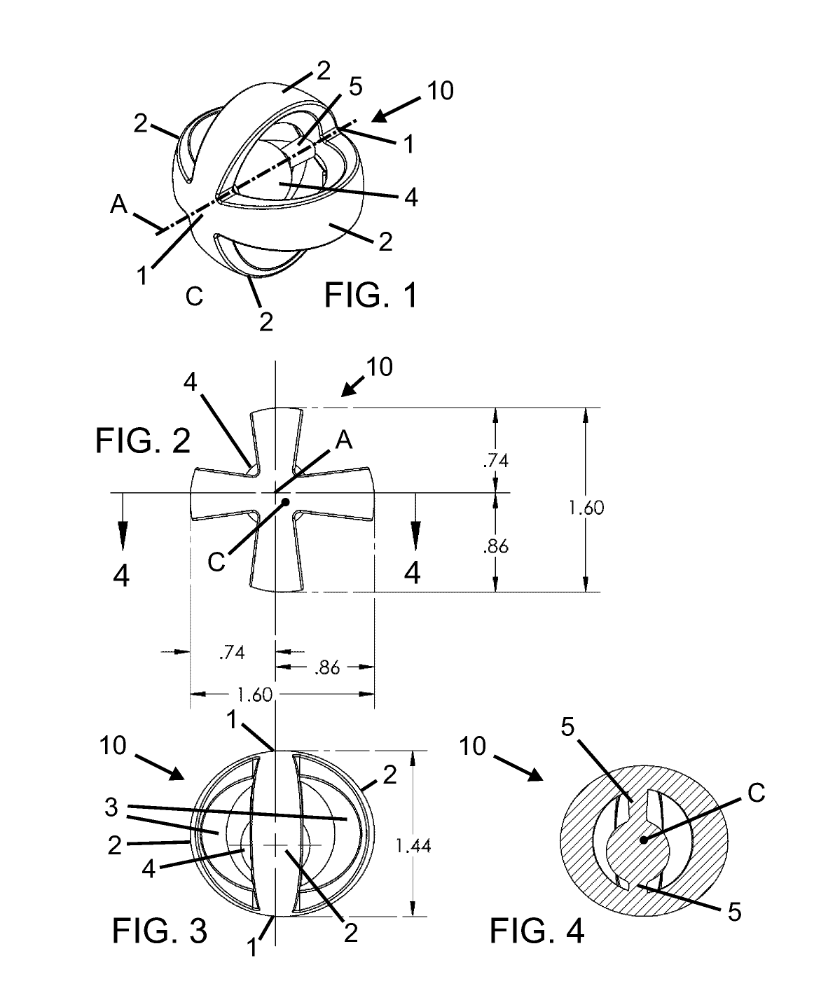

### DETAILED DESCRIPTION OF THE PREFERRED EMBODIMENT

Referring now to the figures, an embodiment of a toy according to the invention is depicted generally at 10. The toy 10 includes a central toy axis A which extends centrally between opposed poles 1, and at least three ribs 2 (four ribs 2 in the depicted example) which extend between the poles 1 and which define an outer envelope of toy 10 which, in the depicted example, is generally ellipsoid, spheroid or otherwise out of round. Each of the ribs 2 includes a wedge portion 3 facing inward generally towards the center of the toy 10.

Such optional structure described above which, while deemed advantageous to practice of the invention, is disclosed for illustration purposes only and not considered limiting of the scope of the invention. Such optional structural embodiment can advantageously be manufactured according to the approach set forth in the disclosure of U.S. Pat. Pub. 2005/0181175 A1 (Wechsler, application Ser. No. 10/963,443 filed Oct. 12, 2004) published Aug. 18, 2005 and entitled INTEGRAL FRAME STRUCTURES AND MANUFACTURING METHOD, which application has issued as U.S. Pat. No. 8,486,510 B2 on Jul. 16, 2013 and is entitled INTEGRAL FRAME STRUCTURES, the entirely of which is herein incorporated by reference.

Notwithstanding the above description, it is noted that there is no requirement that a toy according to an embodiment of the invention be any one of spherical, non-spherical or that indeed such toy need take a symmetric shape about the toy axis. However, while not deemed essential to the invention, outer surfaces of the toy which will come into contact with a support or striking surface are advantageously provided with constant positive curvature to facilitate rolling of the toy on, for example, a planar surface, such as a table or the floor. In addition, the center of gravity of the toy in accordance with an embodiment of the invention should preferably not be located too far offset from the geometric center and/or present an outer envelope shaped so as to create toy structure having only one position in which it can achieve stable mechanical equilibrium, which would thereby interfere with or impede continued rolling after being set in motion on a support surface.

As mentioned above herein, one or more structurally eccentric configurations are effective for providing a desired erratic behavior of the toy 10. In the depicted example, two such configurations are optionally employed in combination, although either could be provided independently, each in another toy according to the invention.

The first configuration for providing a displacement of the geometric center from the center of gravity (eccentricity) includes the provision of an eccentrically weighted structure 4 which is positioned closer to a first of poles 1 than another of poles 1, which serves to shift the center of gravity away from a geometric center C. The weight is attached to the remainder of the toy structure conveniently by one or more connecting spokes (two spokes 5 being depicted by example), or can simply be an integral inward extension or bulging of one of the poles 1.

The second configuration includes arranging the longitudinal axis A eccentric of (offset from) the geometric axis, the latter which intersects (passes through) the geometric center C.

Although not shown in the depicted example, another degree of erratic (eccentric) behavior could be achieved by making one of more of the ribs 2 thicker or heavier than remaining one(s) of the ribs 2.

As best seen in the cross-sectional view of FIGS. 3 and 4, the toy 10 is further made in the general shape of a spheroid or ellipsoid, to impart an optional additional degree of unpredictable bounce and/or roll.

A further degree of animal interest can be imparted to the toy by optionally infusing an aromatic component in a composition used to comprise the toy 10. For example, when made of rubber or other elastomer, or other suitable formable material, the toy could optionally be infused with, for example, an essential oil, such as, in the example of a cat toy, which is depicted, with catnip oil. In a particularly advantageous embodiment, the elastomer used is natural rubber, more preferably a superior grade of natural rubber.

The toy 10 in the example shown is directed to a cat toy, the dimensions of which are shown in the figures to provide an example of a suitable contemplated configuration and sizing when produced in a natural rubber or compound of similar density.

Materials of construction can include natural or synthetic rubber, other elastomeric material, plastic, including nylon, etc., or any other suitable non-toxic material or combination of materials conventionally used in the fabrication of pet (or human) toys.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

What is claimed is:

1. A toy, comprising:
a body comprising the toy including a center of gravity which is dimensionally offset from a geometric center of the body.

2. A toy according to claim 1, wherein said body comprises:
opposed poles through which a longitudinal axis passes centrally; and
at least three ribs extending between the poles, outward facing surfaces of said at least three ribs and said poles at least partially defining an outer envelope of said body.

3. A toy according to claim 2, wherein said body further comprises an eccentrically weighted structural portion which is positioned closer to a first one of said opposed poles that to a second one of said opposed poles.

4. A toy according to claim 3, wherein said eccentrically weighted structural portion is attached to a remainder of said body by at least one connecting spoke.

5. A toy according to claim 2, wherein the longitudinal axis is laterally offset from a geometric axis codirectional therewith which passes through the geometric center.

6. A toy according to claim 1, wherein said body includes a general shape which is non-spherical.

7. A toy according to claim 1, wherein said body is comprised of natural rubber.

8. A toy according to claim 1, wherein said body is infused with catnip essential oil.

9. A toy according to claim 8 wherein said body is comprised of natural rubber.

10. A method of playing with a pet, comprising:
providing a body comprising a toy including a center of gravity which is dimensionally offset from a geometric center of the body; and
bouncing or rolling the toy in the presence of the pet.

11. A method according to claim 10, wherein said body comprises:
opposed poles through which a longitudinal axis passes centrally; and
at least three ribs extending between the poles, outward facing surfaces of said at least three ribs and said poles at least partially defining an outer envelope of said body.

12. A method according to claim 11, wherein said body further comprises an eccentrically weighted structural portion which is positioned closer to a first one of said opposed poles that to a second one of said opposed poles.

13. A method according to claim 12, wherein said eccentrically weighted structural portion is attached to a remainder of said body by at least one connecting spoke.

14. A method according to claim 11, wherein the longitudinal axis is laterally offset from a geometric axis codirectional therewith which passes through the geometric center.

15. A method according to claim 10, wherein said body includes a general shape which is non-spherical.

16. A method according to claim 10, wherein said body is comprised of natural rubber.

17. A method according to claim 16, wherein:
said pet is a cat; and
said body is infused with catnip essential oil.

18. A method of providing entertainment to a cat, comprising:
providing a cat toy comprising rubber which has been infused with catnip essential oil; and
making the cat toy accessible to the cat.

19. A method according to claim 18, wherein said step of making the cat toy available includes one of rolling or bouncing the toy in the presence of the cat.

20. A method according to claim 18, wherein said cat toy comprises a body which includes:
opposed poles through which a longitudinal axis passes centrally; and
at least three ribs extending between the poles, outward facing surfaces of said at least three ribs and said poles at least partially defining an outer envelope of said body.
